(19) United States
(12) Patent Application Publication
(10) Pub. No.: US 2004/0239493 A1
(43) Pub. Date: Dec. 2, 2004

(54) Windshield attachable electronic display sign apparatus

(76) Inventor: Miriam M. Miller, Lakeland, FL (US)

Correspondence Address: LINGBECK PATENT LAW OFFICE, P.O. BOX 500, ST. MICHAEL, MN, 55376, US

(21) Appl. No.: 10/445,424

(22) Filed: May 28, 2003

(51) Int. Cl. B60Q 1/52

(52) U.S. Cl. 340/471

(57) ABSTRACT

A windshield attachable electronic display sign apparatus for communicating and displaying messages upon the windshield of a vehicle. The windshield attachable electronic display sign apparatus includes a display sign member including a first housing having top, bottom, and front walls and also having a removable back panel, and also including a first display screen being disposed in said front wall, and further including a microprocessor being disposed in the first housing, and also including a receiver being disposed in the first housing and being connected to the microprocessor, and being adapted to removably attach to a windshield of a vehicle; and also includes a keyboard member for transmitting messages to the display sign member and having on/off switches, and including a second housing having front and back walls, and also including a keypad being disposed upon the front wall of the second housing, and further including a transmitter being disposed in the second housing and being connected to the keypad; and further includes fastening members for attaching the display sign member to the windshield of a vehicle; and also includes a fastener for attaching the keyboard to one's person.

### BACKGROUND OF THE INVENTION

1. Field of the Invention

The present invention relates to electronic display signs for vehicles and more particularly pertains to a new windshield attachable electronic display sign apparatus for communicating and displaying messages upon the windshield of a vehicle.

2. Description of the Prior Art

The use of electronic display signs for vehicles is known in the prior art. More specifically, electronic display signs for vehicles heretofore devised and utilized are known to consist basically of familiar, expected and obvious structural configurations, notwithstanding the myriad of designs encompassed by the crowded prior art which have been developed for the fulfillment of countless objectives and requirements.

Known prior art includes U.S. Pat. No. 6,304,174; U.S. Pat. No. 6,300,870; U.S. Pat. No. 6,154,126; U.S. Pat. No. 6,124,783; U.S. Pat. No. 5,892,439; and U.S. Pat. No. Des. 352,737.

While these devices fulfill their respective, particular objectives and requirements, the aforementioned patents do not disclose a new windshield attachable electronic display sign apparatus. The prior art includes display screens being attached to various parts of vehicles for displaying particular messages.

### SUMMARY OF THE INVENTION

The general purpose of the present invention, which will be described subsequently in greater detail, is to provide a new windshield attachable electronic display sign apparatus which has many of the advantages of the electronic display signs for vehicles mentioned heretofore and many novel features that result in a new windshield attachable electronic display sign apparatus which is not anticipated, rendered obvious, suggested, or even implied by any of the prior art electronic display signs for vehicles, either alone or in any combination thereof. The present invention includes a display sign member including a first housing having top, bottom, and front walls and also having a removable back panel, and also including a first display screen being disposed in said front wall, and further including a microprocessor being disposed in the first housing, and also including a receiver being disposed in the first housing and being connected to the microprocessor, and being adapted to removably attach to a windshield of a vehicle; and also includes a keyboard member for transmitting messages to the display sign member and including a second housing having front and back walls, and also including a keypad being disposed upon the front wall of the second housing and having on/off switches, and further including a transmitter being disposed in the second housing and being connected to the keypad; and further includes fastening members for attaching the display sign member to the windshield of a vehicle; and also includes a fastener for attaching the keyboard to one's person. None of the prior art includes the combination of the elements of the present invention.

There has thus been outlined, rather broadly, the more important features of the windshield attachable electronic display sign apparatus in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

It is an object of the present invention to provide a new windshield attachable electronic display sign apparatus which has many of the advantages of the electronic display signs for vehicles mentioned heretofore and many novel features that result in a new windshield attachable electronic display sign apparatus which is not anticipated, rendered obvious, suggested, or even implied by any of the prior art electronic display signs for vehicles, either alone or in any combination thereof.

Still another object of the present invention is to provide a new windshield attachable electronic display sign apparatus for communicating and displaying messages upon the windshield of a vehicle.

Still yet another object of the present invention is to provide a new windshield attachable electronic display sign apparatus that is easy and convenient to set up and use.

Even still another object of the present invention is to provide a new windshield attachable electronic display sign apparatus that would be able to display selected messages that could be seen and read by other motorists.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of the display sign member of a new windshield attachable electronic display sign apparatus according to the present invention.

FIG. 2 is a back elevational view of the display sign member of the present invention.

FIG. 3 is a front perspective view of the keyboard member of the present invention.

FIG. 4 is a rear perspective view of the keyboard member of the present invention.

FIG. 5 is a cross-sectional view of the display sign member of the present invention.

### DESCRIPTION OF THE PREFERRED EMBODIMENT

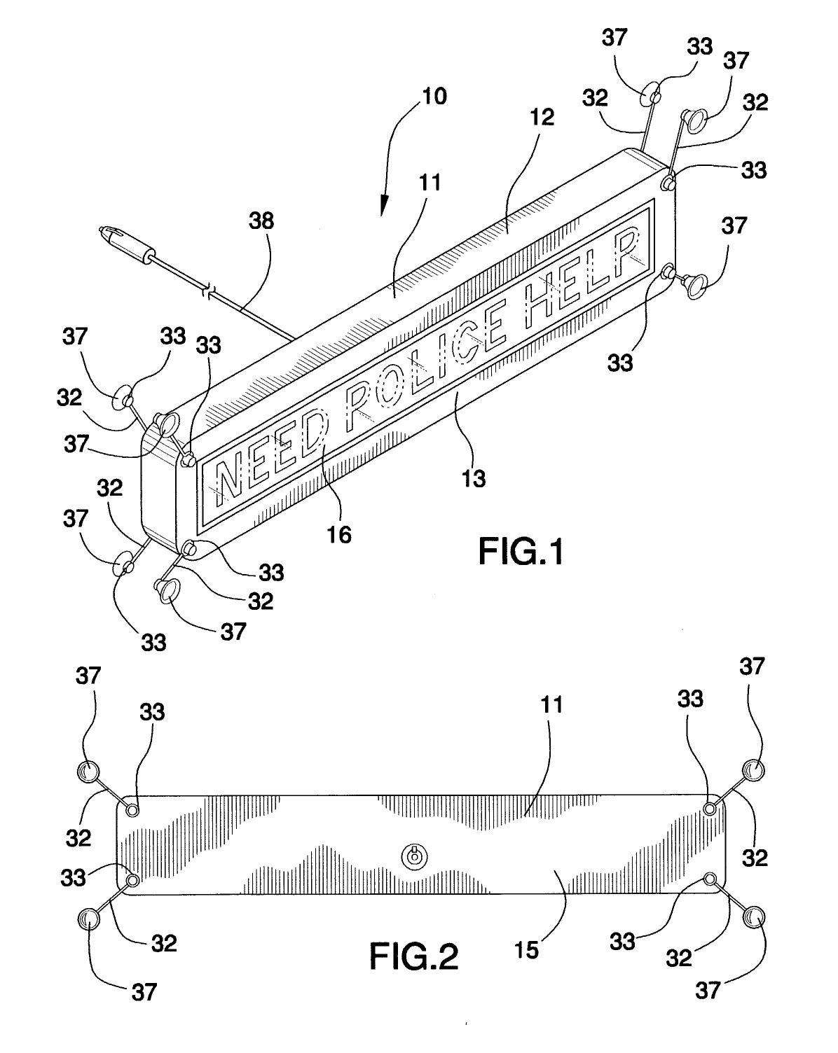

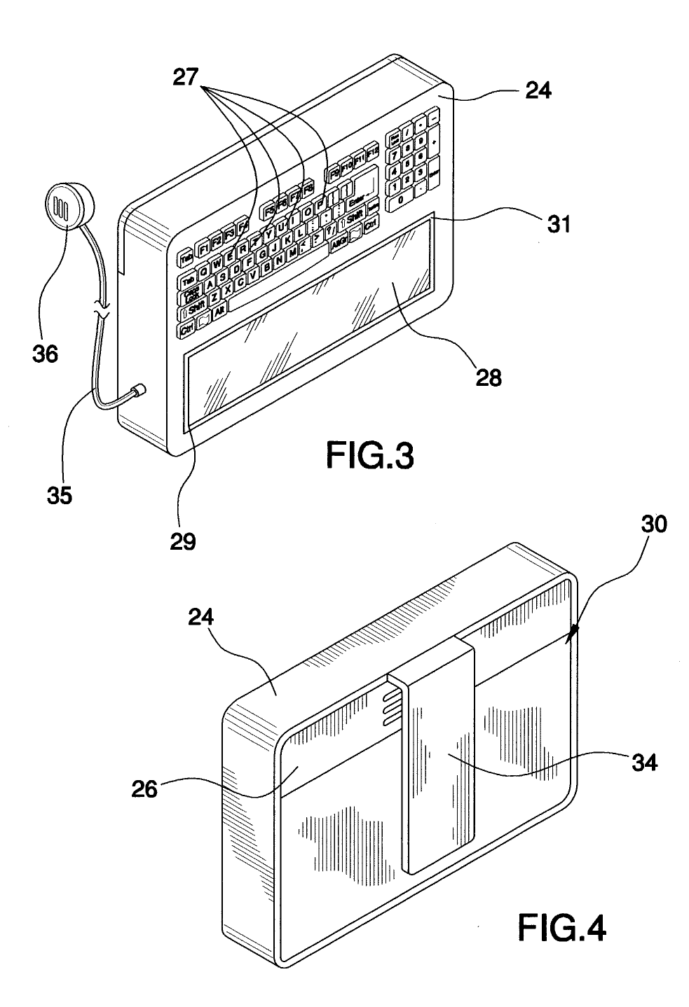

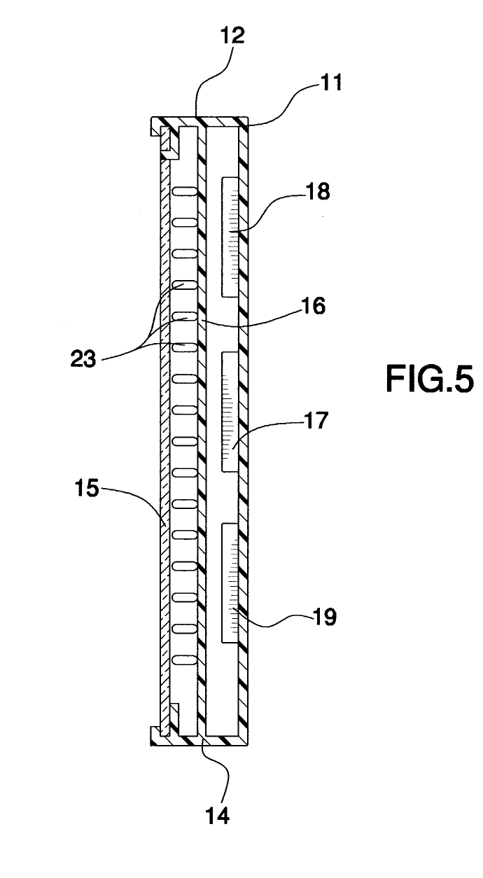

With reference now to the drawings, and in particular to FIGS. 1 through 5 thereof, a new windshield attachable electronic display sign apparatus embodying the principles and concepts of the present invention and generally designated by the reference numeral 10 will be described.

As best illustrated in FIGS. 1 through 5, the windshield attachable electronic display sign apparatus 10 generally comprises a display sign member including a first housing 11 having top, bottom, and front walls 12-14 and also having a removable back panel 15, and also including a display screen 16 being conventionally disposed in the front wall 13, and further including a microprocessor 17 being conventionally disposed in the first housing 11, and also including a receiver 18 being conventionally disposed in the first housing 11 and being conventionally connected to the microprocessor 17, and being adapted to removably attach to a windshield of a vehicle. The display sign member also includes support members 32 being conventionally attached to the first housing 11 and extending outwardly beyond the removable back panel 15 and the front wall 13. The display sign member further includes light-emitting members 23 being conventionally disposed in the first housing 11 behind the first display screen 16 and being conventionally connected to the microprocessor 17 for displaying messages upon the first display screen 16, and also includes a battery pack 19 being conventionally disposed in the first housing 11 and being conventionally connected to the microprocessor 17 and to a power cord 38 for the energizing of the microprocessor. Each support member 32 includes a shaft having eyelets 33 at ends thereof.

A keyboard member for transmitting messages to the display sign member includes a second housing 24 having front and back walls 25,26, and also including a keypad 27 being conventionally disposed upon the front wall 25 of the second housing 24 and having on/off switches, and further including a microprocessor being conventionally disposed in said second housing 24, and also including a transmitter 29 being conventionally disposed in the second housing 24 and being conventionally connected to the keypad 27 and the microprocessor. The keyboard member further includes a second display screen 28 being conventionally disposed in the front wall 25 of the second housing 24 for displaying keyed-in data from the keypad 27, and also includes a battery pack 30 being removably and conventionally disposed in the second housing 24 and being conventionally connected to the transmitter 29 for the energizing thereof, and further includes a microphone assembly including a cable being connected to the microprocessor and also including a microphone being conventionally connected to an end of the cable for verbally keying in the message to be sent to the display sign member.

Fastening members for attaching the display sign member to the windshield of a vehicle include suction cup members 34 being conventionally attached to the eyelets of the shafts of the support members 32 and being suctioned upon the windshield of the vehicle for supporting the display sign member. A fastener for attaching the keyboard member to one's person is a clip 35 being conventionally attached to an outer side of the back wall 26 of the second housing 24.

In use, the user energizes the keyboard member and keys in the desired message using the keypad 27 which is displayed upon the second display screen 28 and which is transmitted by the transmitter 29 to the microprocessor 17; whereupon, the microprocessor 17 turns on the appropriate light-emitting members 23 to display the keyed-in message upon the first display screen 16 which is detachably supported upon the desired windshield of the vehicle with the suction cup members 34.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the windshield attachable electronic display sign apparatus. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A windshield attachable electronic display sign apparatus comprising:
a display sign member including a first housing having top, bottom, and front walls and also having a removable back panel, and also including a first display screen being disposed in said front wall, and further including a microprocessor being disposed in said first housing, and also including a receiver being disposed in said first housing and being connected to said microprocessor, and being adapted to removably attach to a windshield of a vehicle;
a keyboard member for transmitting messages to said display sign member and including a second housing having front and back walls, and also including a keypad being disposed upon said front wall of said second housing and having on/off switches, and further including a microprocessor being disposed in said second housing and being connected to said keypad, and also including a transmitter being disposed in said second housing and being connected to said keypad and to said microprocessor;
fastening members for attaching said display sign member to the windshield of a vehicle; and
a fastener for attaching said keyboard member to one's person.

2. The windshield attachable electronic display sign apparatus as described in claim 1, wherein said display sign member also includes support members being removably attached to said first housing and extending outwardly beyond said removable back panel and said front wall and having eyelets at ends thereof.

3. The windshield attachable electronic display sign apparatus as described in claim 2, wherein said display sign member further includes light-emitting members being disposed in said first housing behind said first display screen and being connected to said microprocessor for displaying messages upon said display screen, and also includes a battery pack being disposed in said first housing and being connected to said microprocessor and to a power cord for the energizing of said microprocessor.

4. The windshield attachable electronic display sign apparatus as described in claim 3, wherein said keyboard member further includes a second display screen being disposed in said front wall of said second housing for displaying keyed-in data from said keypad, and also includes a battery pack being removably disposed in said second housing and being connected to said transmitter for the energizing thereof.

5. The windshield attachable electronic display sign apparatus as described in claim 4, wherein said keyboard member also includes a microphone assembly including a cable being attached to said second housing and being connected to said microprocessor and also including a microphone being attached to an end of said cable.

6. The windshield attachable electronic display sign apparatus as described in claim 5, wherein said fastening members include suction cup members being attached to said eyelets of said support members and being suctioned upon the windshield of the vehicle for supporting said display sign member.

7. The windshield attachable electronic display sign apparatus as described in claim 2, wherein said fastener is a clip being attached to an outer side of said back wall of said second housing.
